(19) United States
(12) Patent Application Publication
(10) Pub. No.: US 2008/0081861 A1
(43) Pub. Date: Apr. 3, 2008

(54) Composition comprising ethylene copolymer

(76) Inventors: George Wyatt Prejean, Orange, TX (US); Stephen P. Musemeche, Orange, TX (US)

Correspondence Address: E I DU PONT DE NEMOURS AND COMPANY;LEGAL PATENT RECORDS CENTER, BARLEY MILL PLAZA 25/1122B, 4417 LANCASTER PIKE, WILMINGTON, DE, 19805, US

(21) Appl. No.: 11/542,403

(22) Filed: Oct. 3, 2006

(51) Int. Cl. C08K 3/26

(52) U.S. Cl. 524/425

(57) ABSTRACT

Disclosed is a composition that can be used for producing surface covering. The composition comprises, consists essentially of, or consists of an ethylene copolymer, a decoupler, a filler, a cellulosic material, and optionally a plasticizer wherein the decoupler includes a dimer of an organic acid or acid derivative, a trimer of an organic acid or acid derivative, or combinations thereof; the acid itself optionally has about 15 to 30 carbon atoms; the filler can include CaCO₃; the cellulosic material can include wood flour; and the plasticizer includes processing oils, epoxidized oils, polyesters, polyethers, polyether esters, or combinations of two or more thereof.

The invention relates to a composition comprising ethylene copolymer that can be used as, for example, surface covering, to an article such as mulch produced from the composition, and to a surface covered with the article.

Shredded tires can be used as surface or covering such as artificial mulch, but they are encumbered with deficiencies including unpleasant odor, possible metal contamination, heavy metals, and inadequate supply. Surface or ground covering desirably has the properties of pleasant scent, little or no metal contamination, little or no heavy metal content, and relatively high specific gravity to prevent wash out during heavy rains. Development of such surface covering product at low cost would be a great contribution to the art.

### SUMMARY OF THE INVENTION

A composition comprises, consists essentially of, or consists of an ethylene copolymer, a decoupler, a filler, a cellulosic material, and optionally a plasticizer wherein the decoupler includes a dimer of an organic acid or acid derivative, a trimer of an organic acid or acid derivative, or combinations thereof; the acid itself optionally has about 15 to 30 carbon atoms; the cellulosic material can include wood flour; and the plasticizer includes processing oils, epoxidized oils, polyesters, polyethers, polyether esters, or combinations of two or more thereof.

### DETAILED DESCRIPTION OF THE INVENTION

The composition disclosed herein desirably comprises, based on the total weight of the composition, about 5 to about 40, about 10 to about 30, or about 15 to about 25, weight % of the ethylene copolymer; about 0.1 to about 10, about 1 to about 7, or about 2 to about 5 such as about 3, weight % of the plasticizer; about 0.01 to about 5, about 0.1 to about 2, or about 0.1 to about 1 such as about 0.4, weight % of the decoupler; about 30 to about 90, about 30 to about 80, or about 50 to about 70, weight % of the filler; and about 0 to about 30, about 1 to about 25, about 3 to about 20, or about 5 to about 15, weight % of the cellulosic material. The composition can have a specific gravity of <2 such as from about 1 to about 1.9, about 1.2 to about 1.7 about 1.3 to about 1.6, or about 1.3 to about 1.5 such as about 1.45.

Ethylene copolymer can include one comprising repeat units derived from ethylene and comonomer including vinyl ester; vinyl acetate, α-olefin, α,β-unsaturated carboxylic acid or ester thereof, vinylidene, or combinations of two or more thereof. Examples of α-olefins include propylene, butene, pentene, 4-methyl-1-petene, hexene, octene, decene, dodecene, or combinations of two or more thereof. Vinyl ester can include esters of saturated C₁₋₄ carboxylic acids such as vinyl acetate, vinyl propionate, vinyl butyrate, or combinations of two or more thereof. Examples of α,β-unsaturated carboxylic acids include (meth)acrylic acid, maleic acid, fumaric acid, a C₁₋₈ alkyl ester of the acid, or combinations of two or more thereof. The copolymer can further include repeat units derived from additional comonomer such as CO, SO₂, an epoxy-containing carboxylic acid, or combinations of two or more thereof.

Ethylene/vinyl acetate copolymer can include copolymers comprising repeat units derived from ethylene, vinyl acetate, and optionally an additional comonomer. Vinyl acetate and/or comonomer incorporated into the copolymer can vary from about 1 to about 45, about 3 to about 35, or 6 to 30, weight % of the copolymer. The comonomer can include an unsaturated carboxylic acid or its derivatives, such as maleic anhydride or maleic acid. A combination of two or more different ethylene/vinyl acetate copolymers can be used.

An ethylene copolymer can be produced by any means well known to one skilled in the art.

For example, a tubular reactor-produced ethylene/alkyl (meth)acrylate copolymer, which denotes an ethylene copolymer produced at high pressure and elevated temperature in a tubular reactor and is generally stiffer and more elastic than autoclave produced ethylene/alkyl acrylate copolymer. Tubular reactor produced ethylene/alkyl acrylate copolymers of this nature are commercially available under the tradename Elvaloy® AC from E. I. du Pont de Nemours & Company, Wilmington, Del. (DuPont).

The ethylene copolymer can comprise, by weight, based on the ethylene copolymer, about 40 to about 95, about 50 to about 90, or about 70 to about 88% of repeat unit derived from ethylene and about 5 to about 60, about 10 to about 50, or about 12 to about 30% of repeat units derived from the comonomer including the additional comonomer (about 10 to about 100% of the comonomer) and can have a melt index range from about 0.1 to about 400, about 0.1 to about 50, or about 0.1 to about 10 g/10 min (ASTM 1238, 190° C., 2.16 Kg). Two or more ethylene copolymers can be blended together.

Examples of ethylene copolymers include ethylene/vinyl acetate, ethylene/acrylic acid or its ionomers, ethylene/methacrylic acid or its ionomers, ethylene/methyl acrylate, ethylene/ethyl acrylate, ethylene/isobutyl acrylate, ethylene/n-butyl acrylate, ethylene/isobutyl acrylate/methacrylic acid or its ionomers, ethylene/n-butyl acrylate/methacrylic acid or its ionomers, ethylene/isobutyl acrylate/acrylic acid or its ionomers, ethylene/n-butyl acrylate/acrylic acid or its ionomers, ethylene/methyl methacrylate, ethylene/vinyl acetate/methacrylic acid or its ionomers, ethylene/vinyl acetate/acrylic acid or its ionomers, ethylene/vinyl acetate/carbon monoxide, ethylene/methyl acrylate/carbon monoxide, ethylene/n-butyl acrylate/carbon monoxide, ethylene/isobutyl acrylate/carbon monoxide, ethylene/vinyl acetate/monoethyl maleate, ethylene/methyl acrylate/monoethyl maleate, or combinations of two or more thereof.

Wishing not to be bound by theory, a decoupler such as dimer acid or trimer acid can enhance elongation and increase melt index such as at high filler loadings. Decoupler can also include a monomeric organic acid such as stearic acid, oleic acid, linoleic acid, linolenic acid, or combinations of two or more thereof. Such dimer or trimer acids can be derived from mono- or poly-unsaturated acids in which one or more of the olefinic bonds of a monomeric acid molecule reacts with one or more of the olefinic bonds of other monomeric acid molecules to form acyclic, cyclic, aromatic or polycyclic dimers and/or trimers. Generally a mixture of structures results, with cyclic addition products predominating. For example, dimer acids (CAS Number 61788-89-4) and trimer acids (CAS Number 68937-90-6) derived from C₁₈ fatty acids such as linoleic acid can be used. The unsaturated bonds remaining after dimerization or trimerization can be hydrogenated to provide fully saturated dimers or fully saturated trimers. Dimer and trimer acids can be obtained from Arizona Chemical Company, Panama City, Fla. (such as Unidyme®). Mixtures of the these acids can be employed such as a mixture containing at least 51% and about 55% trimer acids (measured by gas chromatography) is commercially available as Unidyme®. Mono-, di-, and/or tri-valent metal salts of these organic acids, including calcium, zinc, magnesium, or combinations of two or more thereof, salts of fatty acids can be used.

The plasticizer can include processing oils, epoxidized oils, polyesters, polyethers, polyether esters, or combinations of two or more thereof.

The processing oils can include paraffinic, aromatic, naphthenic, or combinations of two or more thereof. Paraffinic oils tend to “bleed” from blends. Bleeding is normally not desirable, but could be useful in specialty applications, for example, in concrete forms where mold release characteristics are valued. Naphthenic acid and aromatic oils are nonbleeding when used in proper ratios. Processing oils can also be subdivided by viscosity range. Thin oils have 100-500 SUS (Saybolt Universal Seconds) at 100° F. (38° C.). Heavy oils can have high as 6000 SUS at the same temperature. Processing oils such as naphthenic and aromatic oils with viscosity of from about 100 to 6000 SUS at 38° C. can be used.

Epoxidized oils can include epoxidized soybean oil and epoxidized linseed oil.

Polyesters, polyethers, and polyether esters are well known to one skilled in the art. A polyester, polyether, and/or polyether ester can also be mixed with one or more processing oils where the processing oil can be present from about 50% or higher by weight.

A filler such as calcium carbonate, calcium sulfate, barium carbonate, barium sulfate, alumina, silica, glass, glass fiber, perlite, or combinations of two or more thereof may modify the density of the composition. The filler can have any particle size or shape. Fine particle size fillers may have a tendency to result in higher blend viscosities.

One or more cellulosic materials can be used such as those obtained from wood and wood products, such as wood flour; wood pulp fibers; non-woody paper-making fibers from cotton; straws and grasses, such as rice and esparto; canes and reeds, such as bagasse; bamboos; stalks with bast fibers, such as jute, flax, kenaf, cannabis, linen and ramie; and leaf fibers, such as abaca and sisal; paper or polymer-coated paper including recycled paper and polymer-coated paper. Preferably the cellulosic material is from a wood source including softwood sources such as pines, spruces, and firs, and hardwood sources such as oaks, maples, eucalyptuses, poplars, beeches, and aspens. The form of the cellulosic materials from wood sources can be sawdust, wood chips, wood flour, or combinations of two or more thereof.

In addition to sawdust, agricultural residues and/or waste can be used. Agricultural residues are the remainder of a crop after the crop has been harvested. Examples of such suitable residues include residues from the harvesting of wheat, rice, and corn, for example. Examples of agricultural waste suitable for use herein include straw, corn stalks, rice hulls, wheat, oat, barley and oat chaff, coconut shells, peanut shells, walnut shells, jute, hemp, bagasse, bamboo, flax, and kenaff, and combinations thereof.

The cellulosic materials may be screened through various screens, e.g., a 30-mesh or a 40-mesh screen, to obtain a mixture of different size material. The size of the cellulose material used in the composition of the present invention can range from about 10 to about 100 mesh or about 40 to about 100 mesh.

The wood flours include soft and hard woods and combinations thereof. Preferable wood flours are oak and pine, available as OAK 4037 (40 mesh) and PINE 402050 (40 mesh), respectively from American Wood Fibers of Schofield, Wis. Maple wood flour can also be used.

The composition can also comprise about 0.001 to about 10 weight % of an additive including one or more extender resins, waxes, foaming agents, crosslinking agents, UV stabilizer, carbon black, titanium dioxide, other pigments or dyes, optical brighteners, surfactants, hydrolytic stabilizers, anti-static agents, fire-retardants, lubricants, reinforcing agents (e.g., glass fiber and flakes), antiblock agents, release agents, processing aids, antioxidants, a tackifier resin, or combinations of two or more thereof. The tackifier may be any tackifier known in the art such as those disclosed in U.S. Pat. No. 3,484,405 including natural and synthetic resins and rosin materials; coumarone-indene resins (e.g., coumarone-indene resins including commercially marketed as Picco-25 and Picco-100); terpene resins including styrenated terpenes (e.g., commercially marketed as Piccolyte S-100, Staybelite Ester #10, or Wingtack 95); butadiene-styrene resins (e.g., Buton100 or Buton 150, a liquid polybutadiene resin); hydrocarbon resins (produced by catalytic polymerization of selected fractions obtained in the refining of petroleum including those marketed as Piccopale-100); styrene hard resins (e.g., disproportionated pentaerythritol esters, and copolymers of aromatic and aliphatic monomer); and rosin (e.g., gum, wood or tall oil rosin, tall oil rosin, dimerized rosin, hydrogenated rosin disproportionated rosin, or esters of rosin), resins.

The composition can be produced by any means known to one skilled in the art such as blending, mixing, or extrusion. For example, a commercial batch-type Banbury, Farrel continuous mixer, or equivalent mixer or can be used for mixing/blending. Also for example, dry components can be charged to a suitable vessel such as reactor, bowel, container, extruder, or other mixing chamber. Alternatively, masterbatch of smaller components such as the decoupler and/or plasticizer can be prepared and then injected directly into a vessel to obtain thorough mixing. A mix cycle of about 1 to about 120 minutes at about 125° C. to about 200° C. can be effective or sufficient. Once blends are mixed, routine commercial practices may be used, such as underwater melt cutting plus drying or use of sheeting plus chopping methods, to produce a final composition in pellet form. Alternately, the hot mixture also may be immediately fabricated into a final form, e.g., sheeting, molding, strip, or combinations of two or more thereof.

An article such as mulch, sheet, film, foam, or combinations of two or more thereof can be produced from the composition by any means known to one skilled in the art. For example, mulch can be produced by mixing, by any means known to one skilled in the art, the components in a batch mixer such as a Banbury or a continuous mixer such as a Ferrel Contenious Mixer to produce the composition and shredding the composition to a variety of physical form a such as nugget-like mulch product.

Also for example, the composition may be processed industrially into final sheet, film or three-dimensional solid form by using standard fabricating methods well known to those skilled in the art such as extrusion, calendering, injection or rotomolding, extrusion coating, sheet laminating, sheet thermoforming, or combinations of two or more thereof.

### EXAMPLES

The examples are provided to illustrate, not to be construed as to unduly limit the scope of, the invention.

In Example 1, ethylene vinyl acetate copolymer (60 g; available from DuPont, Wilmington, Del. as VAX® 470; contained 18% vinyl acetate and had a MI of 0.7 g/10 min), a trimer of linoleic acid (and/or linolenic acid) (1.2 g; derived from tall oil obtained as a byproduct in the treatment of pine pulp and obtained from Arizona Chemical Company, Panama City, Fla. as Unidyme®; CAS 68937-90-6), a naphthenic oil (9 g; obtained from Ergon, Vicksburg, Miss. as L750 oil), CaCO₃ (199.8 g; obtained from Imerys, Roswell, Ga.), and pine flour (30 g; obtained from American Wood fibers, Memphis, Tenn.) were mixed in a Haake batch mixer for 20 minutes at 160° C. and 50 rpm's.

In Example 2, the run was carried out the same as that in Example 1 except that stearic acid was used to replace the trimer of linoleic acid.

The results are shown in the following table.

| Composition | Elong^{A} | UT^{B} | Yield^{C} | MI^{D} | SG^{E} | Flex Mod^{F} |
|---|---|---|---|---|---|---|
| Example 1 | 50 | 413 | 348 | 0.34 | 1.45 | 52000 |
| Example 2 | 16 | 483 | 483 | 0.32 | 1.45 | 46000 |

^{A}Mean break elongation (%), determined by ASTM D-638.
^{B}Mean U.T. strength (%), determined by ASTM D-638.
^{C}Yield strength (psi), determined by ASTM D-638.
^{D}Melt index (g/10 min), determined by ASTM 1238, 190° C., 2.16 Kg.
^{E}Specific gravity determined by ASTM D-792.
^{F}Flex modulus (psi), determined by ASTM D-790.

The table shows that these two examples had identical composition except that Example 2 contained stearic acid, not the trimer of linoleic and/or linolenic acids. Example 1 yielded more than three times the elongation as compared to Example 2. Wishing not to be bound by theory, it was probably due to the unexpected enhanced decoupling between the polymeric binder and the fillers provided by the trimer acid as compared to the stearic acid. The increase in elongation (toughness) could allow cutting or shredding the composition, when used for surface covering such as mulch, without crumbling and to prevent crumbling when the mulch is subject to the normal expected stresses during use. The table also shows an unexpected increase in the modulus of Example 1 composition.

1. A composition comprising an ethylene copolymer, a decoupler, a filler, and a cellulosic material wherein the decoupler includes a dimer of an organic acid or its derivative, a trimer of an organic acid or its derivative, or combinations thereof; and the acid itself has about 15 to 30 carbon atoms.

2. The composition of claim 1 further comprising a plasticizer including processing oil, epoxidized oil, polyester, polyether, polyether ester, or combinations of two or more thereof.

3. The composition of claim 1 wherein the plasticizer is a processing oil.

4. The composition of claim 2 wherein the ethylene copolymer includes ethylene/vinyl acetate, ethylene/acrylic acid or its ionomers, ethylene/methacrylic acid or its ionomers, ethylene/methyl acrylate, ethylene/ethyl acrylate, ethylene/isobutyl acrylate, ethylene/n-butyl acrylate, ethylene/isobutyl acrylate/methacrylic acid or its ionomers, ethylene/n-butyl acrylate/methacrylic acid or its ionomers, ethylene/isobutyl acrylate/acrylic acid or its ionomers, ethylene/n-butyl acrylate/acrylic acid or its ionomers, ethylene/methyl methacrylate, ethylene/vinyl acetate/methacrylic acid or its ionomers, ethylene/vinyl acetate/acrylic acid or its ionomers, ethylene/vinyl acetate/carbon monoxide, ethylene/methyl acrylate/carbon monoxide, ethylene/n-butyl acrylate/carbon monoxide, ethylene/isobutyl acrylate/carbon monoxide, ethylene/vinyl acetate/monoethyl maleate, ethylene/methyl acrylate/monoethyl maleate, or combinations of two or more thereof.

5. The composition of claim 2 wherein the ethylene copolymer comprises repeat units derived from ethylene, comonomer, and optionally additional comonomer wherein the comonomer includes vinyl ester, α-olefin, α,β-unsaturated carboxylic acid or ester thereof, vinylidene, or combinations of two or more thereof and the additional comonomer includes CO, SO₂, an epoxy-containing carboxylic acid, or combinations of two or more thereof.

6. The composition of claim 5 wherein the comonomer is the vinyl ester.

7. The composition of claim 6 wherein the comonomer is vinyl acetate

8. The composition of claim 7 wherein ethylene copolymer comprises two different ethylene/vinyl acetate copolymers.

9. The composite of claim 2 wherein the decoupler is one or more metal salt of the organic acid and the metal is calcium, zinc, magnesium, or combinations of two or more thereof.

10. The composition of claim 9 wherein the comonomer is vinyl acetate.

11. The composition of claim 9 wherein the plasticizer comprises processing oil.

12. The composition of claim 10 wherein the plasticizer comprises naphthenic oil.

13. The composition of claim 2 wherein the filler is calcium carbonate, calcium sulfate, barium carbonate, barium sulfate, alumina, silica, glass, glass fiber, perlite, or combinations of two or more thereof.

14. The composition of claim 12 wherein the filler is calcium carbonate.

15. The composition of claim 2 wherein the cellulosic material includes wood, wood product, wood pulp fiber, non-woody paper-making fiber from cotton, straw, grass, cane, reed, bamboo, stalk with bast fibers, leaf fibers, or combinations of two or more thereof.

16. The composition of claim 2 wherein the cellulosic material includes wood flour, sawdust, wood chip, or combinations of two or more thereof.

17. The composition of claim 2 wherein the cellulosic material is wood flour.

18. An article produced from a composition comprising an ethylene copolymer, a decoupler, a filler, and a cellulosic material wherein the decoupler includes a dimer of an organic acid or its derivative, a trimer of an organic acid or its derivative, or combinations thereof; and the acid itself has about 15 to 30 carbon atoms.

19. The article of claim 18 wherein the composition comprises an ethylene vinyl acetate copolymer, a trimer of a C18 unsaturated acid, naphthenic oil, CaCO₃, and wood flour.

20. A surface having covered thereon an article as recited in claim 19.
